(19) United States
(12) Patent Application Publication
(10) Pub. No.: US 2010/0205979 A1
(43) Pub. Date: Aug. 19, 2010

(54) Integrated LNG Re-Gasification Apparatus

(76) Inventors: Mark C. Gentry, The Woodlands, TX (US); Mark A. Danaczko, Houston, TX (US); Robert E. Sandstrom, Sugar Land, TX (US)

Correspondence Address: EXXONMOBIL UPSTREAM RESEARCH COMPANY, P.O. Box 2189, (CORP-URC-SW 359), Houston, TX, 77252-2189, US

(21) Appl. No.: 12/682,003

(22) PCT Filed: Oct. 3, 2008
(86) PCT No.: PCT/US08/78754

§ 371 Date: Apr. 7, 2010

(30) Foreign Application Priority Data
Nov. 30, 2007 (US) 61004878

(51) Int. Cl. F17C 9/04; F17C 13/08

(52) U.S. Cl. 62/50.3; 62/53.2

(57) ABSTRACT

The described invention relates to an integrated LNG re-gasification apparatus suitable for broad use and effective utilization of LNG containers comprising: a) modular storage tank holding structures adapted for storing and accessing LNG containerized in one or more storage tanks; b) a heat exchange re-gasification chamber adapted for converting said LNG to natural gas using a working fluid of higher temperature than the LNG; c) fluid transfer means for transporting the LNG from said storage tanks to the at least one heat exchange re-gasification chamber; d) at least one working fluid holding tank; e) fluid transfer means for transporting the working fluid from said holding tank to the at least one heat exchange re-gasification chamber; f) fluid transfer means for transporting a cooled working fluid, to one or more ancillary refrigeration or air conditioning units.

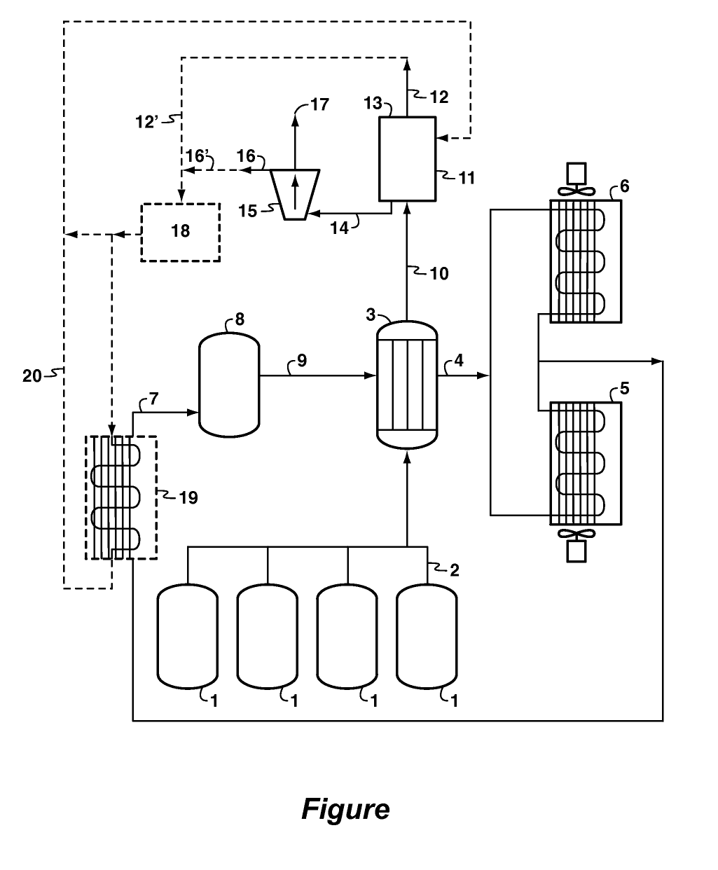

### CROSS-REFERENCE TO RELATED APPLICATION

This application claims the benefit of U.S. Provisional Patent Application No. 61/004,878 filed on Nov. 30, 2007, the entirety of which is incorporated by reference herein.

### FIELD OF INVENTION

This invention relates generally to an apparatus and method for the effective utilization of liquefied natural gas (LNG).

### BACKGROUND OF THE INVENTION

Transporting LNG in large, insulated ships between liquefaction terminals and import terminals has long become the dominant mode of shipping LNG. However, transportation of LNG in smaller containers from the import terminals over rail or road, often referred to as transshipment, has also been growing in recent years. Transshipping LNG over existing roads and rails allows access to markets that lack an established gas distribution pipeline network and eliminates the need to construct expensive pipelines.

The current prevailing LNG delivery chain starts at the export terminal where the produced gas is liquefied into LNG and loaded onto large ocean-going ships for transport to market. Once the LNG carrier arrives at the import terminal, the LNG cargo is offloaded into storage, re-gasified, and fed into the gas distribution pipeline network where the gas is delivered to the end user. Conversely, in a typical LNG transhipment delivery chain, the LNG cargo is loaded into smaller insulated containers that can fit on rail cars, trucks or water borne vessels smaller than typical LNG tankers. The LNG cargo can be loaded into the containers either at the export terminal (and shipped using a standard container ship instead of a LNG carrier) or at the import terminal prior to re-gasification. Once the LNG is in the containers, it is shipped via the rail cars, trucks or water borne vessels to the customer as containerized LNG and typically re-gasified (converted from liquid to gas, by heating) on location. One shortcoming of the conventional LNG delivery concept (pipeline network) is that is can only deliver gas to customers on or near a pipeline. However, transshipment can deliver gas anywhere by any of road, rail, and coastal or inland waterways too shallow for typical LNG vessels. This is a clear advantage for remote locations and developing societies where the demand or potential utility for gas exists, but is not sufficient to justify the expense of a pipeline. Thus LNG transshipment is already operating, to a limited extent, in developed countries but much more broadly in developing countries without large networks of gas pipelines.

Advantages of using liquefied gas to enable continuous, smooth operation of electrical power plants are known, see for example, U.S. Pat. No. 4,055,050. Here a portion of excess gas from a pipeline is liquefied for subsequent re-gasification and fed to a boiler unit for power production when the gas supply is disrupted or demand for power is increased. A cooling water circuit is provided that condenses in a condenser unit the exhaust steam from the turbine. The resulting warmed water is subsequently directed to the re-gasification heat exchanger where cooled by heat exchange with the liquefied gas and then is further cooled in a cooling tower chamber before returning to the condenser unit.

Further, current literature addresses using the inherent cooling capacity of LNG, for example in a Rankine cycle where a working fluid is condensed and then expanded to improve the thermodynamic performance in a combined power plant, see U.S. Pat. App. No. 2003/0005698. The residual cooling capacity of the LNG, after being used in a heat exchanger to condense the working fluid, is used in chilling air that in turn is suitable for use as a cold air supply to a separate combustion gas turbine using as fuel part of the thus regasified LNG, the remainder distributed by pipeline. Additionally, methods of efficiently producing, transporting, storing and distributing natural gas has been addressed, see U.S. Pat. No. 6,298,671. LNG is re-gasified in accordance with known means on offshore platforms, transported by pipeline for storage in subterranean formations, and re-introduced into a natural gas pipeline when needed.

In view of both increasing and disbursing widely the use of LNG, there exists a need to configure efficient means to utilize LNG containers and make the most efficient use of the LNG contents at local delivery sites. As is apparent in the art, substantial energy and efforts go into the preparation of the LNG. Modern needs for both efficiency and improved localized technical capacities counsel careful planning to recover all that is possible.

### SUMMARY OF THE INVENTION

The described invention relates to an integrated LNG re-gasification apparatus comprising: a) one or more modular storage tank holding structures adapted for storing and accessing LNG containerized in one or more modular storage tanks; b) at least one heat exchange re-gasification chamber said chamber being adapted for converting said LNG to natural gas using a working fluid of higher temperature than the LNG and that is physically separated from said LNG and said natural gas; c) fluid transfer means for transporting the LNG from said storage tanks to the at least one heat exchange re-gasification chamber; d) at least one working fluid holding tank; e) fluid transfer means for transporting the working fluid from said holding tank to the at least one heat exchange re-gasification chamber; f) fluid transfer means for transporting a cooled working fluid, converted from the working fluid in transferring heat to the LNG in the at least one heat exchange re-gasification chamber, to one or more ancillary refrigeration or air conditioning units, or, to a subsystem connection point for transporting the cooled working fluid, or portion thereof, to the one or more ancillary refrigeration or air conditioning units; g) fluid transfer means for receiving and transporting the working fluid of a higher temperature than the LNG to the at least one working fluid holding tank; and, h) fluid transfer means for flowing said natural gas from the at least one heat exchange re-gasification chamber to a boiler for burning said natural gas to provide heat for converting water into steam and hot water, or to a second subsystem connection point for transporting said natural gas to said boiler.

In one or more preferred embodiments the apparatus above will comprise said refrigeration or air conditioning units integrated into said apparatus and which units comprise means for transferring one or more streams of refrigerants, comprising cooled fluid or gas produced in said refrigeration or air conditioning units, to ancillary equipment or sites for further cooling use. The refrigeration or air conditioning units may further contain the fluid transfer means for receiving and transporting the working fluid, heated to a temperature higher than that of the LNG by the absorption of heat from the refrigeration or air conditioning unit refrigerants, to the at least one working fluid holding tank, said fluid transfer means optionally may be supplied with additional heating equipment between the refrigeration or air conditioning units and the working fluid holding tank.

In a further preferred embodiment said optional heating equipment is supplied with a portion of steam from said boiler or a heated stream of fluid from said portion of steam. Said boiler can be integrated into said apparatus and contain means for transferring steam produced therein, or at least a major portion thereof, to ancillary equipment or sites for further heating use.

### BRIEF DESCRIPTION OF THE DRAWING

The present invention and its advantages will be better understood by referring to the following detailed description and the attached drawing. The Figure depicts a process diagram of an embodiment of the invention where four LNG containers are mounted in or on an integrated apparatus that provides steam and hot produced with regasified LNG (for at least partial use in electrical power generation), and cooled air from air conditioning that uses the working fluid cooled from the regasifying of the LNG.

The invention will be described in connection with its preferred embodiments. However, to the extent that the following detailed description is specific to a particular embodiment or a particular use of the invention, this is intended to be illustrative only, and is not to be construed as limiting the scope of the invention. On the contrary, it is intended to cover all alternatives, modifications and equivalents that may be included within the spirit and scope of the invention, as defined by the appended claims.

### DETAILED DESCRIPTION OF PREFERRED EMBODIMENTS

Certain embodiments of the invention apparatus provide directly for at least three useful outputs: electrical power, heating, and cooling. Returning to the Figure, one embodiment of an apparatus of the present disclosure utilizes four skid mounted modular LNG storage containers 1, though the number of containers could be more or less depending upon the local need, but will comprise at least one such container. Typically such a skid (not shown) will have racks or shelves, or other holding structures for the LNG containers, and will be constructed principally of metal or other stiff, strong construction materials. Structural steel, with suitable cutouts for weight reduction, or heavy duty aluminum is preferred to keep construction easy and keep overall weight, for transfers, relatively light. The holding structures will typically be designed for easy loading and removal of the individual container or containers in accordance with skill in the art. Preferably, the skid-mounted apparatus, or integrated modular construction contemplated in preferred embodiments, will be constructed or adapted for ease of mounting and transporting on the typical transshipment vehicles or vessels in accordance with existing construction and construction design practices.

The containers themselves are known in the industry for transporting liquefied industrial gases, see for instance the intermodal containers available worldwide from Chart Ferox GmbH, Germany. Details for accessing contents and accommodating mounting are available in the company's sales brochures. Any such containers adapted for carrying LNG will be suitable.

The LNG is typically provided from the containers through valves or gates attached to each container into, for example, piping or a piping manifold as a fluid transfer means 2, and directed therein to a re-gasification heat exchanger 3 where heat is absorbed from a working fluid to convert the LNG into gas. The LNG will transit through the heat exchanger being separated physically from the working fluid by barriers. Typically the LNG will be directed through one or more open chambers, to allow for expansion of the liquid to gas, and the working fluid will be directed through heat exchanger chamber in multiple coils or tubing. The working fluid is introduced into the heat exchanger at a temperature greater than that of the LNG and will give up heat to the warming LNG. The heat exchanger will be designed to effect a heat transfer such that the working fluid will exit the coils or tubing to the heat exchanger at temperatures above its freezing temperature level. As will be apparent to one skilled in the art, the temperature range of the working fluid will depend on a number of design parameters (working fluid properties, heater exchanger materials and design, holding tank volume, volume of LNG to be processed, and the like). Selection of materials, for the working fluid, the holding tank and heat exchanger, and design based thereon is well within the skill of one skilled in the art of heat exchanger design.

The natural gas from the LNG regasification module is then directed, typically through more piping as fluid transfer means 10, from the chamber to the firesides of a boiler 11 where it is combined with air or oxygen (not shown), and burned to produce hot water stream 12 and steam stream 14. The steam stream 14 can then be directed to one or more steam turbines 15 and expanded in the turbine to produce power to drive one or more electric generators (not shown) to produce electrical current stream 17. The exhaust gases stream 13 from the burning of the natural gas in the boiler can be used to provide heat for either of the working fluid in stream 7 or additional hot water by the use of additional heat exchangers and any necessary fluid transfer means such as piping (not shown). Such may also be used in some embodiments as a pre-heat stream for the feed stream 10. The exhaust stream 16 from the steam turbine can be similarly used. The heated water stream 12 from the boiler 11 provides the second useful output of the system, typically as heating water. For example, the hot water in the boiler can be circulated through an ancillary radiator system to provide heat to nearby buildings or facilities. The system could be easily retrofitted into an existing district heating system.

A third useful output of certain embodiments of the invention is cooling capacity. The working fluid is used to provide heat to the LNG for re-gasification and will be cooled during the heat exchange process, see above. It is provided to the heat exchanger 3 as a hot or warm working fluid stream 9 and exits as cold working fluid stream 4. This stream can be used for air conditioning by transfer in liquid transfer means, such as piping, to the cool side of one or more refrigeration or air-conditioning units 5 and 6. It can be effectively used in the same radiator system used in the district heating system when ambient temperatures differ greatly, such as seasonally, or instead of the heating system where tropical temperatures predominate. However, since the working fluid can typically reach cryogenic temperatures, below about −73.3° C. (−100° F.), it could be used in more demanding cryogenic, industrial applications such as superconductivity, cryogenic storage and the like.

The cold working fluid stream 4 will be warmed in absorbing the heat of any refrigerants in the refrigeration unit of units 5 or 6, or ambient air from the one or more air-conditioning units, or can be directed by fluid transfer means such as piping from such units back to the working fluid holding tank 8 as a warmed working fluid stream 7. As noted above, exhaust stream 16 heat from the turbine generator 15 or from exhaust gas stream 13 from the burner of the boiler 11, or even a portion of the hot water heating stream 12 can be used to transfer additional heat to the warm working fluid either before entrance or after the exit of the working fluid from the working fluid holding tank 8.

Alternative embodiments of the invention may include ancillary equipment 18 to use the hot water from either or both of the boiler hot water stream 12 or hot water generated by the steam turbine 15. The hot water may alternatively or in addition, be utilized to further heat the working fluid 7 in heat exchanger 19. Then, the hot water may be recycled to the boiler 11 via line 20.

Preferred embodiments of the invention can be of particular benefit in regions where the stand-alone nature of the apparatus is most useful. Since the system is constructed of modular truck-, rail- or vessel-mounted hardware, it can easily be transported to and constructed in remote regions with minimal existing infrastructure.

For example, one application for the system is in arctic oil and gas developments. Arctic applications are typically in remote, difficult to access areas with little, if any, established infrastructure, and have significant power and heating requirements to support the personnel and processes. This system could be used to supply an arctic development with power and heating (and any process cooling, if needed). Once the initial system is constructed, the only re-supply would be modular LNG containers which could be delivered in the warm season when access is easier. As the Arctic development grows, the power plant system could be scaled up with additional LNG containers, re-gasification modules, boilers, and turbines to match the specific power and heating requirements of the application, even accommodating seasonal variations. Since the plant is burning methane gas, the emissions are clean (CO₂ and H₂O) as are typically associated with natural gas. Since the system utilizes standard process equipment (no special vessels, heat exchangers, valves, etc. are required), the operation and maintenance of the system should be straightforward and easily handled with the tools and skills available in typical oil and gas development areas.

A second potential application is a large campus for such activities as universities, governments, research centers, medical facilities and the like where delivering power, heating and cooling with a technology that provides independence from or redundancy with the existing power grid has clear advantages. The invention provides a source of power, cooling and heating that can exist isolated from any other systems. In a government building or medical compound where it is critical to ensure operations in the event of a power failure, this invention could provide a reliable, integrated system to deliver power, heating and cooling. Additional power generated could be sold back the power grid or the system could be scaled to match the given demand of the application or season. A large campus, like a college, could take advantage of the ability to scale the system and utilize the low temperature cryogenic working fluid (used to heat the LNG) to cool various equipment and processes including high powered computers, superconducting magnets for high-energy particle accelerators, and cryogenic freezing of biological material.

When access to re-supply is impossible, this system could provide power and life support for space and subsea exploration. Since the system is scalable, potentially desktop-scale equipment could be developed for applications where size/weight are critical. The cryogenic working fluid could be used with superconductors to facilitate long distance power transmission which is an existing challenge in subsea developments. The water produced during the combustion of the LNG could also be recycled.

As can be appreciated from the above description there are many advantages provided by the use of the invention apparatus. All modular components are straight-forward and fabrication is within current skill in the art. The adaption of known regasification chamber designs to modular component design for use in accordance with the invention can be accomplished by reference to U.S. Pat. No. 6,298,671, references cited therein and other resources available to one skilled in the art. When adapted and combined with the other component units according to the invention, the described apparatus would be capable of operating as an independent unit requiring only re-supply of the LNG. In other words, the system provides power, heating and cooling without dependence on existing power grid or gas pipeline or other power infrastructure. Further, since the system uses natural gas as its fuel, the emissions are CO₂ and H₂O. The system thus has substantially fewer environmental challenges than is typically associated with coal-burning power plants or chloro-fluorocarbon air conditioning systems.

Using the invention modular component design, the system also can be readily scaled to match the demands of a particular application or season. With simple fluid transfer means such as re-sizing the valves, the capacity of the system and be increased or decreased. The ability to construct very small (desktop) scale systems could enable subsea or space applications. Operation and maintenance should also be largely straightforward since the components of the system are standard commercially available process equipment, or capable of design and construction with current technology. Also advantageously, the heating and cooling features of the system can be easily retrofitted to existing equipment that utilizes a central boiler for district heating or cooling.

Having thus described the present invention by reference to certain of its preferred embodiments, it is noted that the embodiments disclosed are illustrative rather than limiting in nature and that many variations and modifications are possible within the scope of the present invention. Many such variations and modifications may be considered obvious and desirable by those skilled in the art based upon a review of the foregoing description of preferred embodiments.

What is claimed is:

1. An integrated LNG re-gasification apparatus comprising:
a) one or more modular storage tank holding structures adapted for storing and accessing LNG containerized in one or more modular storage tanks;
b) at least one heat exchange re-gasification chamber, said chamber being adapted for converting said LNG to natural gas using a working fluid of higher temperature than the LNG and that is physically separated from said LNG and said natural gas;
c) fluid transfer means for transporting the LNG from said storage tanks to the at least one heat exchange re-gasification chamber;
d) at least one working fluid holding tank;
e) fluid transfer means for transporting the working fluid from said holding tank to the at least one heat exchange re-gasification chamber;
f) fluid transfer means for transporting a cooled working fluid, converted from the working fluid in transferring heat to the LNG in the at least one heat exchange re-gasification chamber, to one or more ancillary refrigeration or air conditioning units, or, to a subsystem connection point for transporting the cooled working fluid, or portion thereof, to the one or more ancillary refrigeration or air conditioning units;
g) fluid transfer means for receiving and transporting the working fluid of a higher temperature than the LNG to the at least one working fluid holding tank; and
h) fluid transfer means for flowing said natural gas from the at least one heat exchange re-gasification chamber to a boiler for burning said natural gas to provide heat for converting water into steam and hot water, or to a second subsystem connection point for transporting said natural gas to said boiler.

2. The apparatus of claim 1 wherein said refrigeration or air conditioning units are integrated into said apparatus and contain means for transferring one or more streams of refrigerants, comprising cooled fluid or gas produced in said refrigeration or air conditioning units, to ancillary equipment or sites for further cooling use.

3. The apparatus of claim 2 wherein said refrigeration or air conditioning units further contain the fluid transfer means for receiving and transporting the working fluid, heated to a temperature higher than that of the LNG by the absorption of heat from the refrigeration or air conditioning unit refrigerants, to the at least one working fluid holding tank, said means optionally supplied with additional heating equipment between the refrigeration or air conditioning units and the working fluid holding tank.

4. The apparatus of claim 3 wherein said optional heating equipment is supplied with a portion of steam from said boiler or a heated stream of fluid from said portion of steam.

5. The apparatus of claim 1 wherein said boiler is integrated into said apparatus and contains means for transferring steam produced therein to ancillary equipment or sites for further heating use.

6. The apparatus of claim 1 further comprising a steam turbine configured to receive steam from the boiler to generate at least power and hot water.

7. The apparatus of claim 6 further comprising a fluid transfer means configured to flow the hot water from the steam turbine to an apparatus selected from the group consisting of ancillary equipment, a heat exchanger configured to heat the working fluid of (g), and a combination thereof.

8. The apparatus of claim 7 further comprising a fluid transfer means configured to recycle the hot water from one of the ancillary equipment and the heat exchanger to the boiler.

9. The apparatus of claim 1 wherein the modular storage tanks are configured to carry LNG via transshipment.

10. A method for generating power comprising:
a) providing one or more modular storage tanks containing LNG to an integrated modular unit;
b) flowing said LNG from said storage tanks to a heat exchange regasification chamber having a warm working fluid input from a warm fluid holding tank mounted on said integrated modular unit, the warm working fluid being physically separated from said LNG in said chamber, said chamber being adapted for converting said LNG to natural gas and being mounted on said modular unit;
c) flowing said natural gas to a boiler which burns the natural gas as fuel for converting water to steam;
d) flowing said steam to a steam turbine power generator;
e) reducing the spent steam to a hot water stream;
f) providing the hot water stream to ancillary heating equipment, or, optionally, recycling at least a portion thereof into or as the warm working fluid, after or separate from said use in ancillary heating equipment;
g) taking a cold working fluid from the heat exchange re-gas chamber that has been converted from the warm working fluid by the conversion of the LNG to natural gas, and providing to one or more ancillary refrigeration or air conditioning units; and
h) recycling at least a portion of the cold working fluid after absorption of heat by one or more refrigerants in said one or more refrigeration or air conditioning units to the working fluid holding tank.

11. The method of claim 10 comprising transferring said refrigerants to ancillary equipment or sites for further cooling use.

12. The method of claim 10 comprising additional heating of said cold working fluid after absorbing heat from the one or more refrigerants before providing to the working fluid holding tank.

13. The method of claim 10 comprising providing a portion of the steam from said boiler, or a heat transfer fluid heated by said steam, to said ancillary heating equipment to provide said heating.

14. The method of claim 10, further comprising providing the hot water stream to the boiler after step f).

15. The method of claim 10, wherein the one or more modular storage tanks are configured to carry LNG via transshipment.
